(19) United States
(12) Patent Application Publication
(10) Pub. No.: US 2011/0117767 A1
(43) Pub. Date: May 19, 2011

(54) CONNECTOR DEVICE

(76) Inventor: Hiromitsu Sato, Matsudo-shi (JP)

(21) Appl. No.: 12/681,906

(22) PCT Filed: Nov. 13, 2009
(86) PCT No.: PCT/JP2009/069339

§ 371 Date: Sep. 24, 2010

(51) Int. Cl. H01R 13/62; G06F 12/02

(52) U.S. Cl. 439/345; 711/103; 711/E12.008

(57) ABSTRACT

A plug can be attached into and detached from a receptacle easily and readily without friction. The plug can be held in the receptacle firmly without falling off.

The connector device comprises a receptacle in a duplicator; a plug that is put into the receptacle detachably; a receptacle contact portion in the receptacle; a plug contact portion in the plug, the plug being put into the receptacle so that the plug contact portion comes in contact with the receptacle contact portion; and a forcing unit in the duplicator to move between a pressing position for forcing the plug contact portion of the plug in the receptacle and a release position for releasing it.

### TECHNICAL FIELD

The present invention relates to a connector device for connecting a plug of a USB memory and others to a duplicator and other equipment.

### BACKGROUND OF THE INVENTION

In a conventional connector device, in order to prevent a plug from taking off a receptacle, elastically forcing means such as a leaf spring is provided in one or both of the plug and the receptacle as described in Patent Literatures 1-3.

### PRIOR ART

### Patent Literatures

Patent Literature 1: JP2003-243093A
Patent Literature 2: JP2007-59351A
Patent Literature 3: JP2003-217728A

### PROBLEMS TO BE SOLVED BY THE INVENTION

Force of the elastically forcing means makes the plug difficult to be inserted into the receptacle. If it is forced, the plug or the receptacle is likely to be deformed or broken, and increased friction between the plug and the receptacle makes the connector device less durable.

In a duplicator or a dubbing device in which the same music and video information is simultaneously written into each USB memory attached to a number of USB ports, the USB memories are frequently attached to and detached from the USB memories, and the foregoing problems are significantly caused

In view of the disadvantages in the prior art, it is an object of the present invention to provide a connector device in which a plug is attached to and detached from a receptacle easily and readily without friction, the plug being firmly held in the receptacle without taking off.

### MEANS FOR SOLVING THE PROBLEM

The problem is solved by the present invention as below.

(1) A connector device comprising:

a receptacle in the device;

a plug detachably disposed in the receptacle;

a receptacle contact portion in the receptacle;

a plug contact portion in the plug, the plug putting into the receptacle to enable the plug contact portion to contact the receptacle contact portion; and

a forcing unit moving between a pressing position for forcing the plug contact portion disposed in the receptacle toward the receptacle contact portion and a release position for releasing it.

By the structure, when the forcing unit is in the release position, the plug is inserted in the receptacle. Thereafter, the forcing unit is changed to the pressing position, the inserted plug is firmly held on the receptacle without taking off the receptacle. When the forcing unit is changed to the release position again, the plug is pulled out of the receptacle. Hence, the plug can be easily and readily attached to and detached from the receptacle without friction.

Even if the plug is attached and detached repeatedly, the plug and/or receptacle is not worn, deformed or damaged, thereby improving durability.

(2) The connector device of the item (1) wherein the forcing unit comprises an elastic portion pivotally mounted to the connector device to turn between the pressing position and the release position, the elastic portion contacting part of the plug to push the plug contact portion toward the receptacle contact portion.

After the plug is inserted, the plug contact portion is pushed toward the receptacle contact portion, thereby preventing wear between the contact portions and simplifying the structure of the forcing unit.

(3) The connector device of the item (1), further comprising a switching unit for moving the forcing unit between the pressing position and the release position.

The switching unit is changed between the pressing position and the release position not manually, but by the switching unit.

(4) The connector device of the item (3) wherein the switching unit comprises a solenoid for moving the forcing unit to one of the pressing position and the release position when the solenoid is excited and for moving the forcing unit to the other of the pressing position and the release position when the solenoid is not excited.

The switching unit can be electrically controlled, facilitating automation thereof.

(5) The connector device of any one of the items (1) to (4) wherein the receptacle is provided in a USB port, the plug being for a USB memory.

The plug of the USB memory can be easily and readily attached to and detached from the USB port of the device without friction. The plug is firmly held in the receptacle without taking off.

### ADVANTAGE OF THE INVENTION

According to the present invention, there is provided a connector device in which a plug can be easily and readily attached to and detached from the receptacle, the plug being firmly held in the receptacle without taking off.

### BRIEF DESCRIPTION OF THE DRAWINGS

FIG. 1 is a front perspective view of a duplicator and an automatic flash memory supply device in which a connector device according to the present invention is used;

FIG. 2 is a rear perspective view of the duplicator;

FIGS. 3A and 3B are enlarged vertical sectional side views taken along the line III-III in FIG. 2, the former being that a forcing unit is in a release position, the latter being that the forcing unit is in a pressing position;

FIG. 4 is a front schematic perspective view of the forcing unit and flash memories;

FIG. 5 is an enlarged vertical sectional side view taken along the line V-V in FIG. 1, showing that a pusher is in a rear-limit position;

FIG. 6 is an enlarged vertical sectional side view taken along the line V-V in FIG. 1, showing by solid lines that the pusher is in an intermediate position and by two-dotted lines that it is in a front-limit position;

FIG. 7 is an exploded perspective view of a magazine and relating members thereof;

FIG. 8 is a front perspective view of the magazine and a pusher;

FIG. 9 is a front perspective view of an ejection unit in a basic position;

FIG. 10 is a front perspective view of the ejection unit in a ejecting position;

FIG. 11 is a block diagram showing a frame format of the duplicator and the automatic flash memory supply device and showing a control system as blocks;

FIG. 12 is a flowchart showing operation of the duplicator and the automatic flash memory supply device; and

FIG. 13 is a flowchart showing operation of the duplicator and the automatic flash memory supply device if error occurs.

### EMBODIMENTS FOR CARRYING OUT THE INVENTION

One embodiment of the present invention will be described with respect to appended drawings.

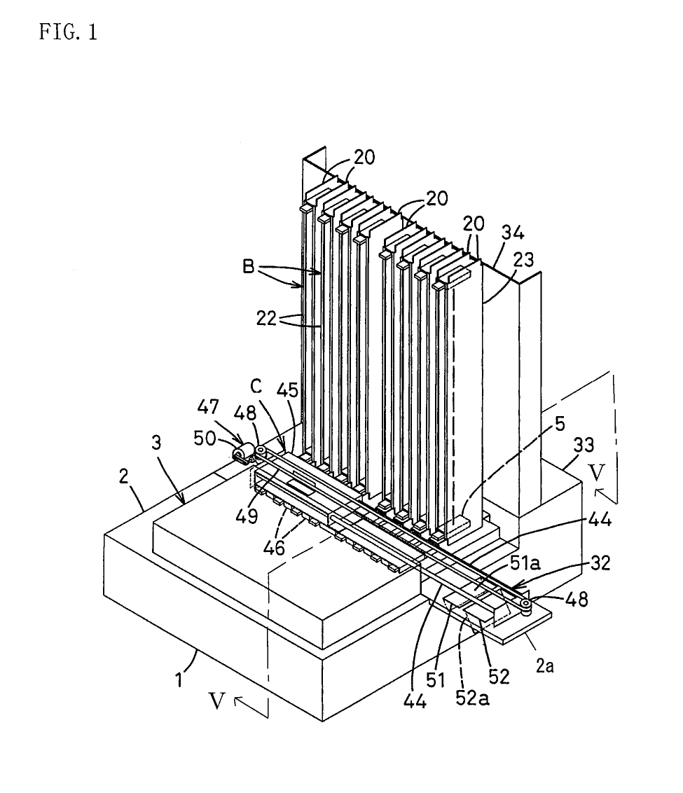

FIG. 1 is a front perspective view of a duplicator for connecting flash memories using a connector device according to the present invention and an automatic flash memory supply device.

As shown in FIG. 1, a horizontally-extending duplicator 3 is provided in the front of a horizontal base plate 2 on the upper surface of a support 1.

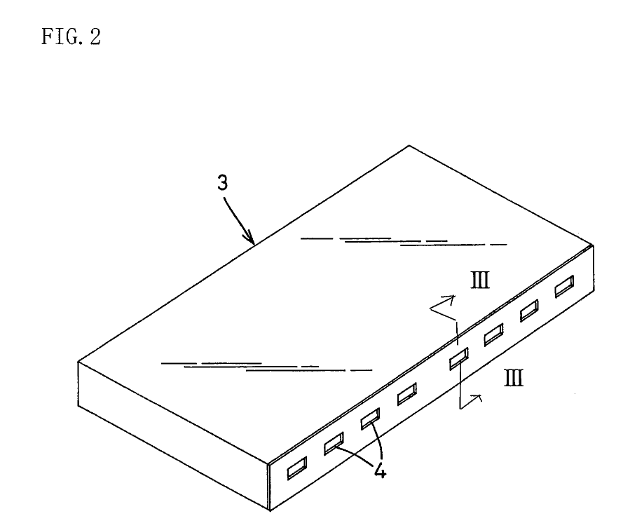

As shown in FIG. 2, USB ports 4 in which eight plugs are put are formed in the rear surface of the duplicator 3, and a duplicator can write music information and video information stored in a master memory (not shown) therein into eight USB flash memories which fit in USB ports 4 simultaneously.

The duplicator 3 can detect whether or not to write them into the eight flash memories 5 fitting in the USB ports 4 and can supply specified information which is not normally written and error information.

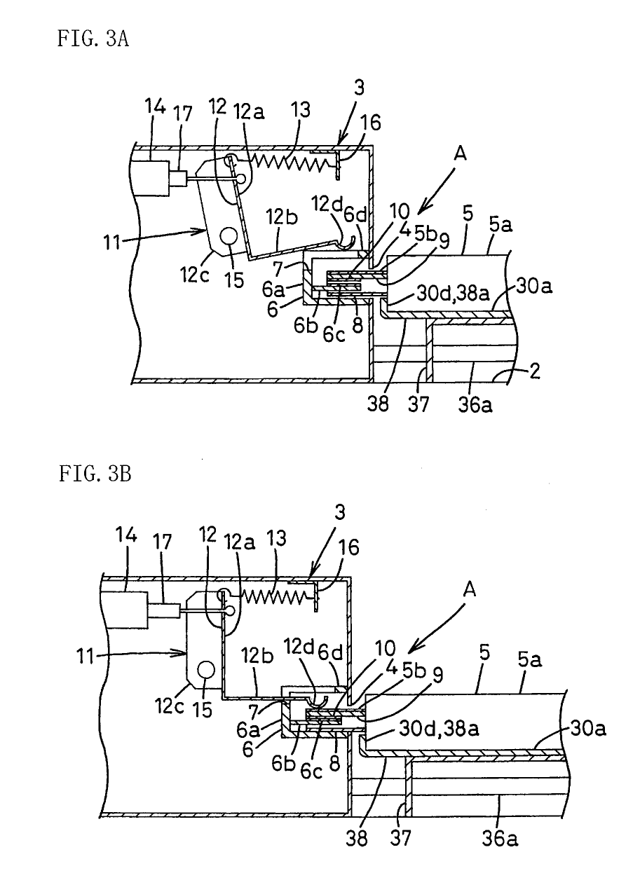

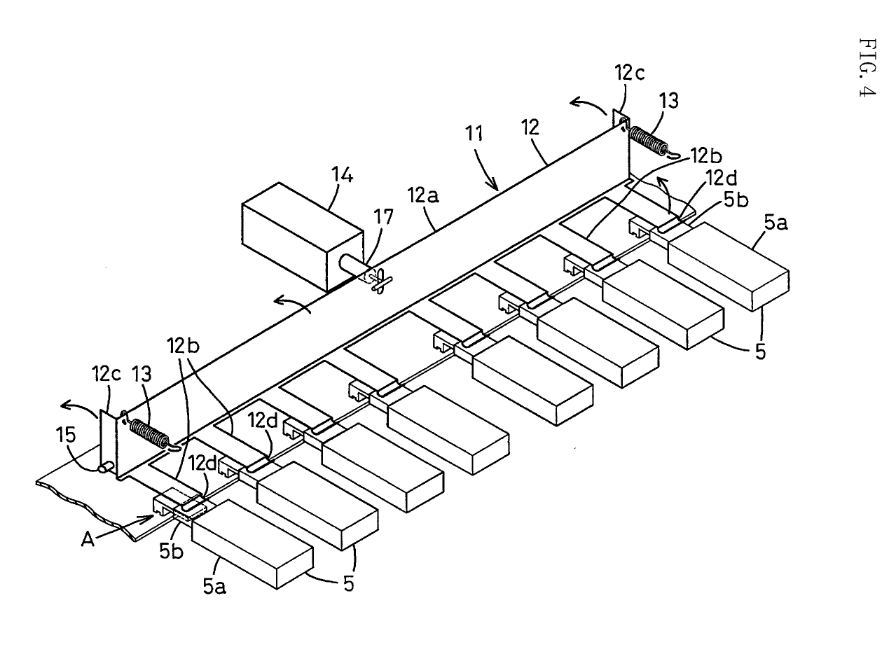

In FIGS. 3A and 3B, a rectangular receptacle 6 which is open at the rear end of the duplicator 3 is formed.

A projection 6b projects rearward on the rear surface of a front wall 6a of the receptacle 6, and a receptacle contact portion 6c is provided on the upper surface of the projection 6d.

A rectangular opening 7 is formed in the front wall 6a and an upper wall 6d of the receptacle 6.

The flash memory 5 comprises a rectangular memory body 5a on which a rectangular plug 5b smaller than the memory body 5a in height and length projects on the front end face of the memory body 5.

The plug 5b comprises a rectangular frame 8; a support 9 fixed to the inner upper surface of the frame 8; and a plug contact portion 10 on the lower surface of the support 9.

The plug contact portion 10 can come in contact with the receptacle contact portion 6c of the receptacle 6 in FIG. 3A when the plug 5b is held in a normal insert position in the USB port 4.

In FIGS. 3A and 3B, in the rear part of the duplicator 3, there is provided a forcing unit 11 for forcing the plug contact portion 10 of the plug 5b disposed in the receptacle 6 toward the receptacle contact portion 6c.

In FIGS. 3A, 3B and 4, the forcing unit 11 comprises an L-like leaf spring 12; a pair of tension coil springs 13, 13 for forcing the leaf spring 12 to turn clockwise in FIGS. 3A and 3B; and a solenoid 14 for forcing the leaf spring 12 to turn counterclockwise against the tension coil springs 13,13 in FIGS. 3A and 3B.

The leaf spring 12 comprises a wider vertical portion 12a and eight elastic portions 12b spaced from each other at the lower end of the vertical portion 12a. The lower ends of side portions 12c formed by bending the vertical portion 12 at right angles forward are pivotally mounted in the duplicator 3 on a transverse shaft 15.

The front end of each of the tension coil spring 13 is mounted to the upper ends of the vertical portion 12a of the leaf spring 12. The rear end of each of the tension coil springs 13 is mounted to a suspending portion 16 of the upper wall of the duplicator 3. Hence, the leaf spring 12 is forced to turn clockwise in FIGS. 3A and 3B.

The solenoid 14 is fixed in the middle in front of the leaf spring 12 in the duplicator 3 with a plunger 17. The rear end of the plunger 17 is secured to the middle of the vertical portion 12a of the leaf spring 12. When the plunger 17 is excited, the plunger 17 moves forward to allow the leaf spring 12 to turn counterclockwise in FIG. 3A against the tension coil spring 13.

When the solenoid 14 is not excited, forward force which exerts the plunger 17 disappears, so that the leaf spring 12 turns clockwise by force of the tension coil spring 13 in FIG. 3B. Hence, a pressing portion 12d at the end of each of the elastic portions 12b presses the upper surface of the plug 5b through the opening 7 of the receptacle 6 to allow the plug contact portion 10 to be pressed onto the receptacle contact portion 6c in a pressing position.

Then, the solenoid 14 is energized and excited to allow the plunger 17 to move forward, so that the leaf spring 12 turns counterclockwise against the force of the tension coil spring 13 in FIG. 3A. The end of the pressing portion 12d leaves the upper surface of the plug 5b, releasing downward force of the plug 5b in a release position in FIG. 3A.

The solenoid acts as switching means for moving the forcing unit 11 between the pressing position and release position.

In the embodiment, the receptacle 6, the plug 5b, the receptacle contact portion 6c, the plug contact portion 10 and the forcing unit 11 constitute a connector device A. In the connector device A, the plug 5b is inserted into the receptacle 6 when the forcing unit 11 is in the release position, and by moving the forcing unit 11 into the pressing position, the plug 5b is held firmly without coming out of the receptacle 6. When the forcing unit is in the release position again, the plug 5b is taken out of the receptacle 6 enabling the plug 5b to fit in or fall off the receptacle 6 easily and readily.

Thus, even if the plug 5b fits in and falls off repeatedly, durability can be improved without wear or deformation of the plug 5b and receptacle 6.

Instead of the tension coil spring 13, a compression spring or another spring may be used. The direction for forcing the spring may be counterclockwise contrary to that in FIG. 3A, and when the solenoid is excited, the leaf spring 12 may turn clockwise against the force of the spring with the plunger 17 in FIG. 3A.

The leaf spring 12 may rise and lower with a motor-driving elevating device (not shown) as switching means while it remains in a posture as shown in FIG. 3B.

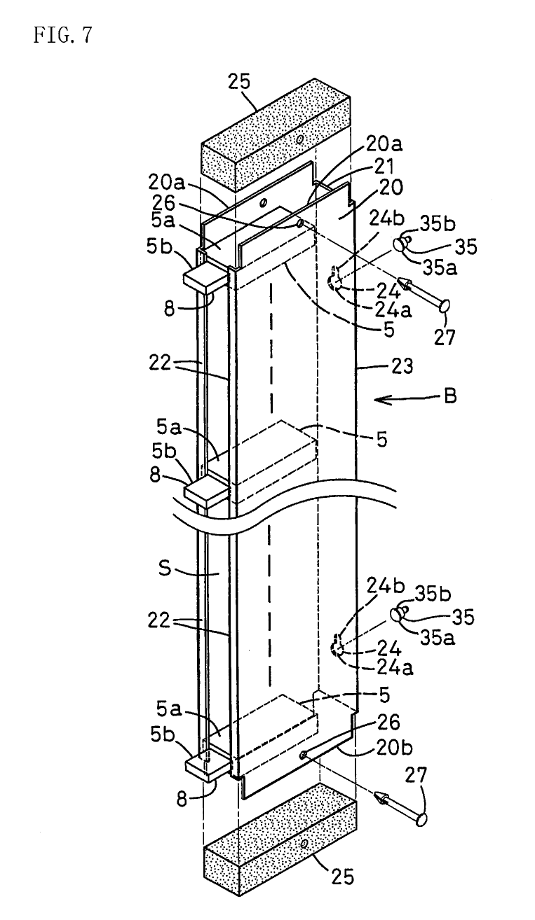

FIG. 7 shows a magazine for stacking and storing a plurality of flash memories vertically.

The magazine B comprises a body storing portion 23 comprising side plates 20,20, a rear plate 21 and a pair of front plates 22,22 covering the sides 20,20, the rear face and the front face of the memory body 5a including the plug 5b in a plurality of flash memories 5. The plug 5b of each of the flash memories 5 projects from a space S between the front plates 22 and 22.

The housing 23 is formed by molding a steel plate as antistatic material or other conductive material.

On the upper ends of the side plates 20,20, upward projections 20a,20a which face each other are provided, and on the lower ends of the side plates 20,20, downward projections 20b,20b are provided.

Pear-shaped holes 24 with which another device is attached are formed in the upper and lower parts of the rear plate 21. The pear-shaped hole 24 comprises a larger-diameter hole 24a and a smaller-diameter hole 24b on the larger-diameter hole 24a.

During transportation, the housing 23 is filled with the stacked flash memories 5. Between the upward projections 20a and 20a and between the downward projections 20b and 20b, elastic materials 26 made of foamed synthetic resin are disposed. The elastic material is fixed by putting a detachable pin 27 such as a nylon rivet into a hole 26 of the projections 20a,20b thereby cushioning impact exerting the flash memories during transportation and preventing the flash memories 5 from falling off the housing 23.

By taking off the pin 27 and removing the elastic material 25 from the housing 23, the flash memories 5 can be taken out of the housing 23 one by one.

The magazine B allows a plurality of flash memories 5 to be stacked in the housing 23 improving storage efficiency and enabling the memories 5 at the minimum volume of the magazine B. The memory body 5a of each of the flash memories 5 is covered with plates, preventing the flash memories 5 from external force. The magazine B is attached to the automatic flash memory supply device C. The lowest flash memory 5 is taken out of the magazine B one by one and supplied to another device such as a duplicator. Hence, the magazine B is suitable for use with the automatic flash memory supply device C.

The magazine B is simple in structure and can be manufactured at low cost.

Then, the automatic flash memory supply device C will be described.

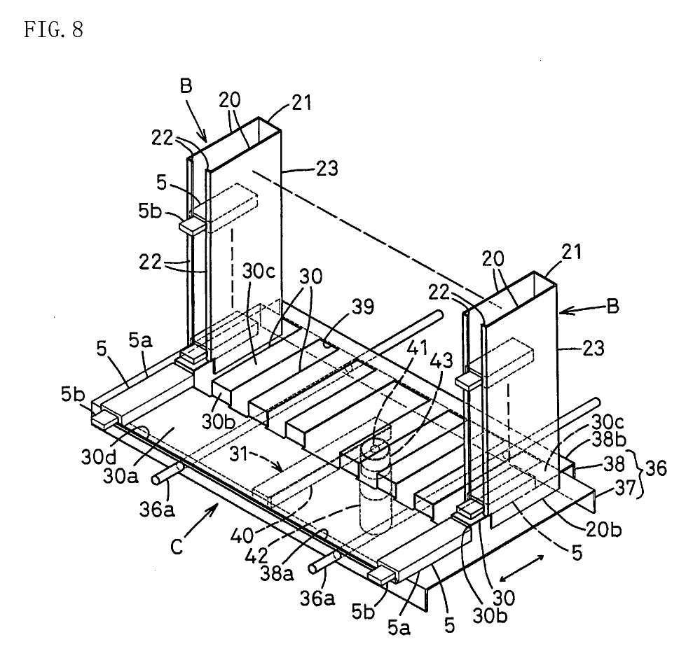

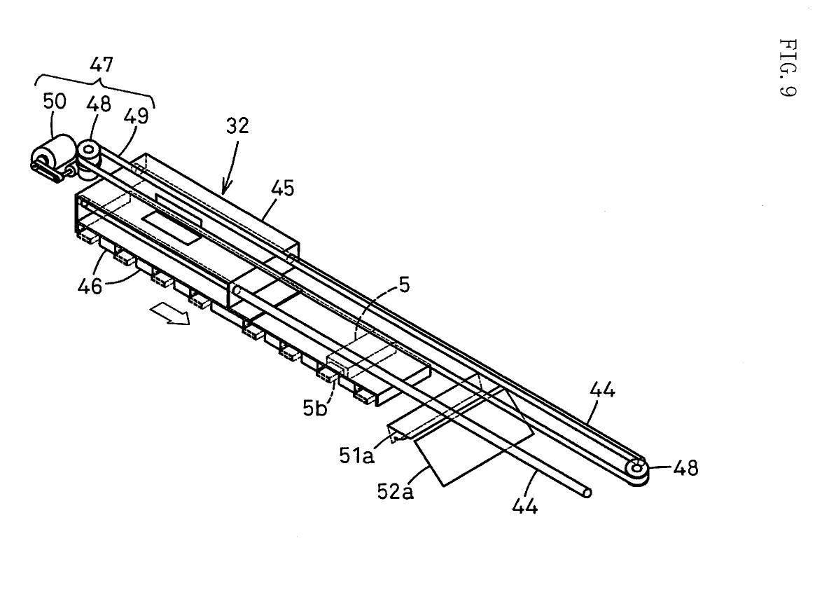

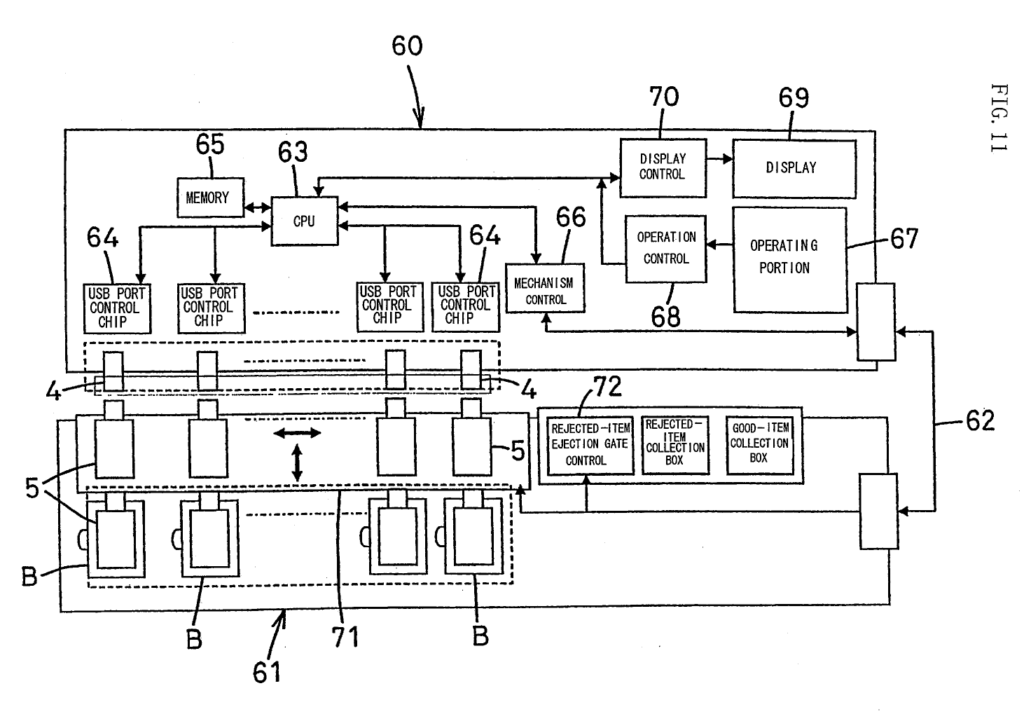

In FIG. 1 and FIGS. 5-10, in order to attach the plug 5b provided at the front end of the memory body 5a of each of the flash memories 5, into the USB port 4 as plug-entering port at the rear of the duplicator 3, the automatic flash memory supply device C comprises the base plate 2 fixed on the front of the duplicator 3; a plurality of magazines B detachably mounted on the base plate 2 to fit with each of the USB ports 4 to store the stacked flash memories 5 such that the plug 5 is placed in the front of the magazine B; a plurality of pushers 30 described later; a longitudinal motion driver 31 for moving all the pushers 30 to a rear-limit position, an intermediate position and a front-limit position: and an ejection unit 32 for ejecting the flash memory 5 from the receiver of the pusher 30 in the intermediate position by moving the flash memory 5 transversely.

Each of the pushers 30 comprises a receiving portion 30a mounted on the base plate 2 at the lower end of each of the magazines B to move forward and backward and to receive the lowest flash memory 5 in the magazine B so that the lowest flash memory 5 does not move forward and backward; a pushing portion 30b standing from the lower part of the receiving portion 30a for pushing the flash memory 5 stored in the receiving portion 30a; a gate portion 30c extending rearward upper than the bottom of the receiving portion 30a by thickness of substantially one flash memory to prevent the next-stage flash memory 5 in each of the magazines B from lowering; and a standing portion 30d at the front end of the receiving portion 30a, the standing portion 30d contacting the front end of the memory body 5a of the flash memory 5 to allow the plug 5b of the flash memory 5 in the USB port 4 to pull out when the pusher 30 moves from the front-limit position to the intermediate position, not to prevent the flash memory 5 to move transversely by the ejection unit 32 when the pusher 30 is in the intermediate position, such that the pusher 30 moves between the rear-limit position where the receiving portion 30a receives the lowest flash memory 5 in the magazine B; the intermediate position where the receiving portion 30a is positioned in front of the magazine B; and the front-limit position where the plug 5b of the flash memory 5 in the receiving portion 30a can be put in the USB port 4.

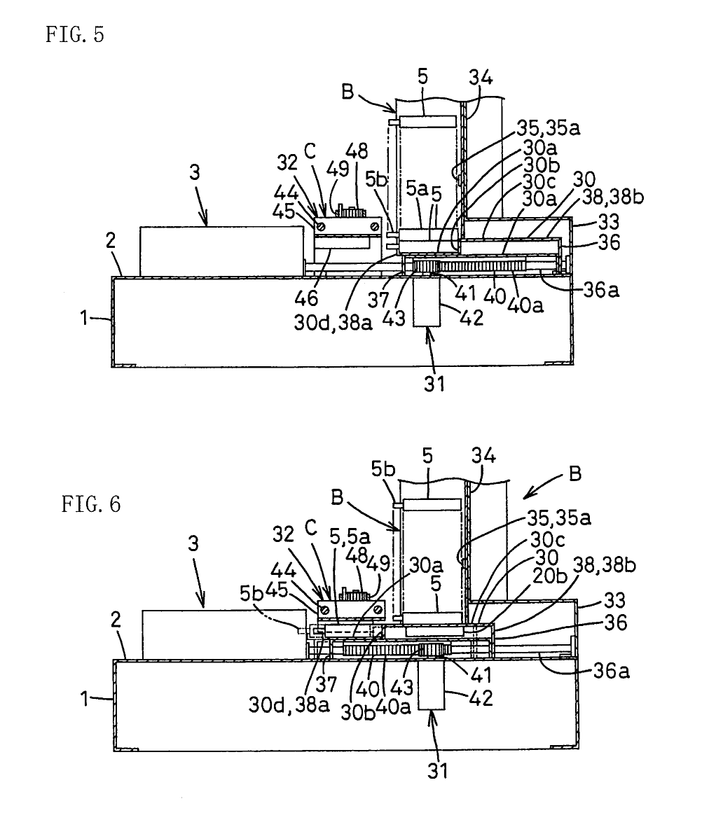

In the back of the base plate 2, a rear hollow support 33 having an opening in the front is provided. A magazine support 34 which stands along the front edge of the rear support 33. In FIGS. 5 and 7, a pair of upper and lower headed pins 35,35 for supporting the magazine B is provided on the front surface of the magazine support 34 in eight lines corresponding to the USB ports 4.

The external diameter of a head 35a of each of the headed pins 35 is slightly smaller than the internal diameter of a larger-diameter hole 24a of the pear-shaped hole 24, while the external diameter of the shank 35b of each of the headed pins 35 is slightly smaller than the smaller-diameter hole 24b of the pear-shaped hole 24 of the magazine B.

The magazine B is easily attached to the magazine support 34 by putting the head 35a through the larger-diameter hole 24a of each of the upper and lower pear-shaped holes 24, pressing down the rear plate 21 onto the front surface of the magazine support 34 and engaging the shank 35b of the headed pin 34 on the upper edge 24b of the pear-shaped hole 24. Reversely the magazine B can be taken off.

On the base plate 2, a longitudinally moving member 36 slides along a pair of guide rods 36a,36a fixed on the support 1.

The longitudinally moving member 36 comprises a U-shaped basic plate 37 and a receiving plate 38 fixed on the basic plate 37. The receiving plate 38 comprises a standing portion 38a at the front end and a stepped standing portion 38b extending from the intermediate portion to the rear end.

The distance from the rear end of the standing portion 38a to the front end of the stepped standing portion 38b is substantially equal to or is slightly larger than the length of the memory body 5a of the flash memory 5 stored in the magazine B. The height of the standing portion 38a is smaller than the distance from the front lower edge of the memory body 5a of the flash memory 5 to the lower surface of the plug 5b when the flash memory 5 is stored in the magazine B.

A plurality of grooves 39 is formed from the front end to the rear end in the stepped standing portion 38b thereby creating the vertical pushing portion 30b and the horizontal gate portion 30c of the right pushers 30 corresponding to the USB ports 4.

In front of the pushing portion 30b of the receiving plate 38, the receiving portion 30a of the pusher 30 has the same width as a total width of the pressing portions 30b and the gate portions 30c. The receiving portion 30a forms the standing portion 30d of the pusher 30.

The receiving plates 38 constitute the eight pushers 30 where the receiving portions 30a and the standing portions 30d are the same.

The eight pushers 30 separately produced may be moved simultaneously by the longitudinal motion driver 31 forward and backward.

The width of the gate portion 30c of the pusher 30 is almost equal to the width of the memory body 5a of the flash memory 5. By putting the gate portion 30c of the pusher 30 between the projections 20b and 20b at the lower end of the magazine B, the magazine B is installed to the magazine support 34. When the gate portion 30c of the pusher 30 is positioned under the magazine B, the upper surface of the gate portion 30c prevents the flash memory 5 in the magazine B from lowering.

The longitudinal motion driver 31 comprises a rack 40 fixed in the middle on the lower surface of the support plate 37 of the longitudinally moving member 36 and having teeth 40a on the side; a geared motor 42 provided on the lower surface of the base plate 2 such that a rotary shaft 41 passes through the base plate 2 to project upward; and a pinion 43 fixed to the rotary shaft 41 of the geared motor 42 to mesh with the teeth 40a of the rack 40.

The ejection unit 32 comprises a pair of guide rods 44,44 fixed at each end on the base plate 3; a transversely moving member 45 which transversely slides along the guide rods 44,44; a plurality of partition plates 46 fixed to the lower surface of the transversely moving member 45; and a mover 47 for moving the transversely moving member 45 transversely. The plurality of partition plate 46 is positioned between the adjacent pushers 30 and 30 when the pusher 30 moves forward and backward, and positioned in the receiving portion 30a to hold the flash memory 5 stored in the receiving portion 30a when the pusher is in the intermediate position, enabling the flash memory 5 stored in the receiving portion 30a of the pusher 30 to move the flash memory 5 transversely by moving with the transversely moving member 45 transversely, the plurality of partition plates 46 engaging with the grooves 39 of the receiving plate 38 when the pusher 30 moves from the intermediate position to the front-limit position. The plurality of partition plates 46 guides the flash memory 5 stored in the receiving portion 30a of the pusher 30 when the pusher 30 is positioned rearward from the intermediate position.

The mover 47 comprises a pair of toothed pulleys 48,48 on the base plate 2; an endless timing belt 49 wound around the toothed pulleys 48,48 and partially mounted to the transversely moving member 45; and a geared motor 50 for turning one of the toothed pulleys 48 normally and reversely.

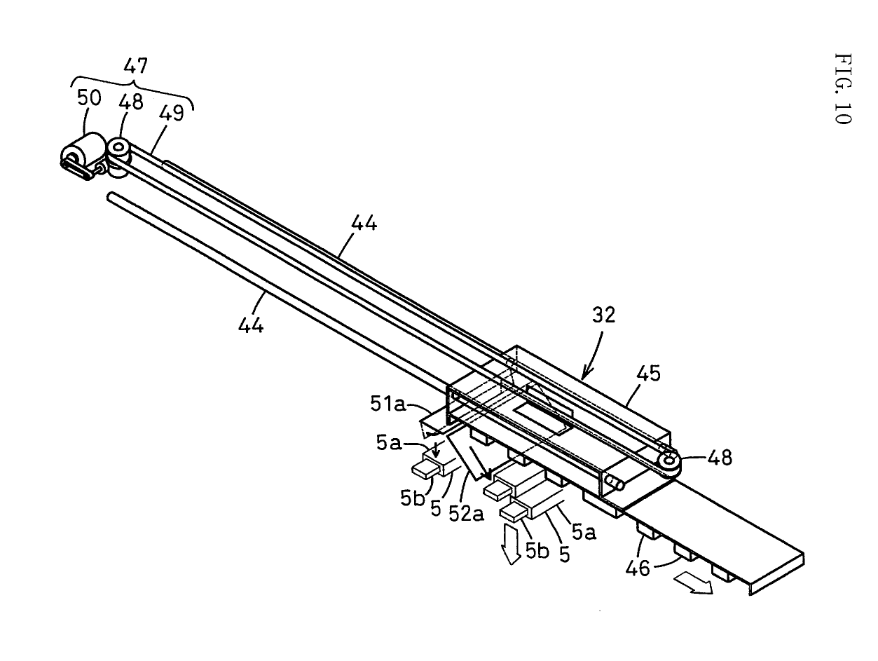

The transversely moving member 45 moves between a basic position where each of the partition plates 46 is in line with the groove 39 in FIGS. 1 and 9, and an ejecting position where all the flash memories 5 between the partition plates 46 can be ejected to a good-item ejection gate 52 described later.

When each of the pushers 30 is positioned in the intermediate position, the partition plates 46 can move transversely because the sides of the receiving portion 30a of each of the pushers 30 are open.

From the right side of the base plate 2, an extension 2a is provided. In the extension 2a, a rejected-item ejection gate 51 and the good-item ejection gate 52 are disposed side by side at a position corresponding to the intermediate position where the receiving portion 30a of the pusher 30 is placed.

In the rejected-item ejection gate 51, a door 51a opens and closes with a solenoid (not shown). According to instructions from a control later described, a flash memory 5 identified as rejected item drops into a rejected-item collection box (not shown) by opening the door 51a as soon as the flash memory 5 passes on the door 51a.

The good-item ejection gate 52 has a chute 52a for guiding flash memories 5 except the flash memory 5 identified as rejected item, into a good-item collection box (not shown).

FIG. 11 schematically shows a control system for the duplicator 3 and the automatic flash memory supply device C.

Numeral 60 denotes a duplicator control system, and 61 denotes an automatic flash memory supply device control system connected to each other with a connector 62.

In the duplicator control system 60, the CPU 63 is connected to a USB port control 64 in each of the USB ports 4; a memory 65 for storing master information such as music information and video information to be duplicated; a mechanism control 66 for controlling a mechanism; an operation control 68 for controlling operating information of an operating portion 67; and a display control 70 for controlling a display 69.

The connector 62 is connected to the mechanism control 66.

In the automatic flash memory supply device control system, the connector 62 is connected to an automatic transportation control 71 for controlling the geared motor 50 in the ejection unit 32; and a rejected-item control 72 for controlling the solenoid for opening and closing the door 51a of the rejected-item ejection gate 51.

Then, with respect to a flowchart in FIG. 12 and FIGS. 1-11, operation and function of the duplicator 3 and the automatic flash memory supply device C will be described

In FIG. 5, when each of the pushers 30 is positioned in the rear-limit position, when the magazine B is mounted in a normal position and when information to be duplicated is stored in the memory 65, an electric power turns on in Step S1; a start switch is pressed in Step S2; it is confirmed that each of the pushers 30 is in the rear-limit position in Step S3; and the solenoid 14 is energized and excited in Step S4, so that the leaf spring 12 moves to the release position in FIG. 3A.

Then, the geared motor 42 turns in a normal direction to allow the pusher 30 to move forward in Step S5.

The pusher 30 moves forward to the front-limit position shown by two dotted lines in FIG. 6, and the flash memory 5 is put in a normal inserting position in FIG. 3A. A sensor (not shown) detects it in Step S6 to enable the geared motor 42 to stop, so that the pusher 30 stops in Step S7.

The solenoid 14 turns off in Step S8, and the leaf spring 12 turns clockwise by the tension coil spring 13 in FIG. 3B. The concave pressing portion 12d at the end of the elastic portion 12b presses the upper surface of the plug 5b through the opening 7 of the receptacle 6. The plug 5b is pressed down to allow the plug contact portion 10 to be pressed onto the receptacle contact portion 6c.

Master information stored in the memory 65 is written into each of the flash memories 5 in Step S9.

The writing completes in Step S10. The solenoid 14 is excited in Step S11, and the leaf spring 12 is moved by the tension coil spring 13 to the release position in FIG. 3A.

The geared motor 42 turns in a predetermined reversing direction and the pusher 30 moves backward in Step S14.

The geared motor 50 turns in a predetermined normal direction, and the transversely moving member 45 at rest in the basic position moves rightward in Step S15.

The transversely moving member 45 reaches the ejecting position, and the sensor (not shown) detects it in Step S16. The geared motor 50 turns reversely and the transversely moving member 45 moves leftward in Step S17.

Before the transversely moving member 45 reaches the ejecting position, the written flash memories 5 stored in the receiving portions 30a of the pushers 30 held between the partition plates 46 and 46 of the transversely moving members 45 are all ejected into the good-item collection box through the good-item ejection gate 52 if no error occurs.

The flash memories 5 are all ejected, and the transversely moving member 45 moved leftward reaches the basic position, and a sensor (not shown) detects it in Step S18 to allow the geared motor 50 to stop, so that the transversely moving member 5 stops in the basic position.

Thereafter, the geared motor 42 turns reversely again to allow the pusher 30 to move backward in Step S20.

A sensor (not shown) detects that the pusher 30 reaches the rear-limit position in Step S21. The geared motor 42 stops to allow the pusher 30 to stop in the rear-limit position in Step S22.

When the pusher 30 stops in the rear-limit position, all the flash memories 5 in each of the magazines B lowers by one memory. The lowest flash memory 5 is stored in the receiving portion 30a of the pusher 30 in the rear-limit position and is ready for the next cycle.

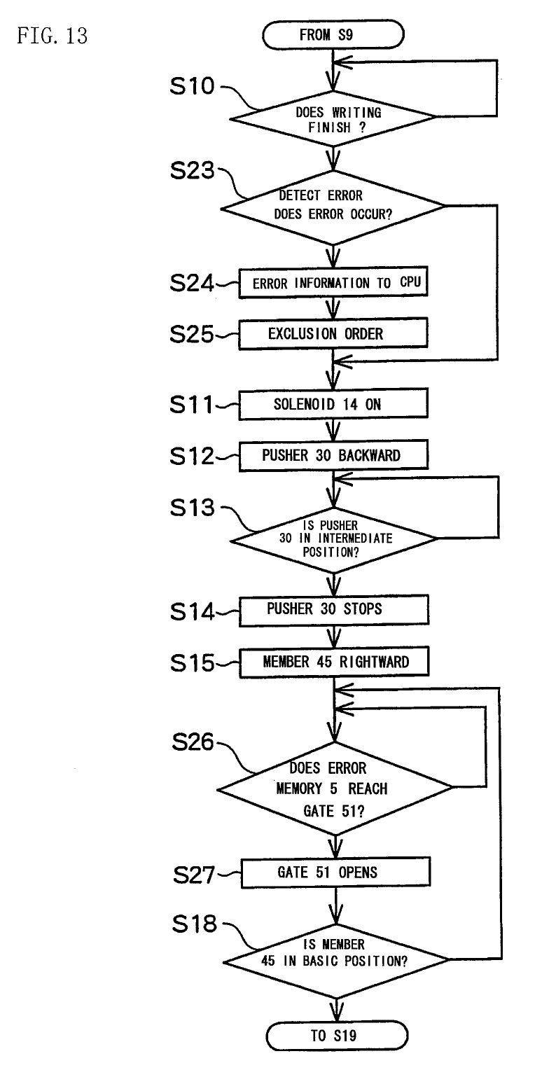

In the foregoing, all the flash memories 5 are normally processed without error. However, if any of the eight flash memories are not normally written owing to any reason, the corresponding USB port control chip 64 detects that an error occurs in any one of the flash memories 5 in Step S23 after master information stored in the memory 65 is written in each of the flash memories 5 in Step S10 as above in FIG. 13. Error information specifying the flash memory 5 where the error occurs is transmitted from the USB port control chip 6 to the CPU 63 in Step S24. From the CPU 63, instructions ejecting the flash memory 5 in which the error occurs are transmitted to the automatic transportation mechanism control 71 to the rejected-item ejection gate control 72 via the mechanism control 66 and the connector 62 in Step S25. Thereafter, Steps S11 to S15 are processed as well. On the way of rightward motion of the transversely moving member 45, as soon as the flash memory 5 in which the error occurs reaches the rejected-item ejection gate 51 in Step S26, the door 51a of the rejected-item ejection gate 51 opens in Step S27, and only the flash memory 5 in which the error occurs drops into the rejected-item collection box.

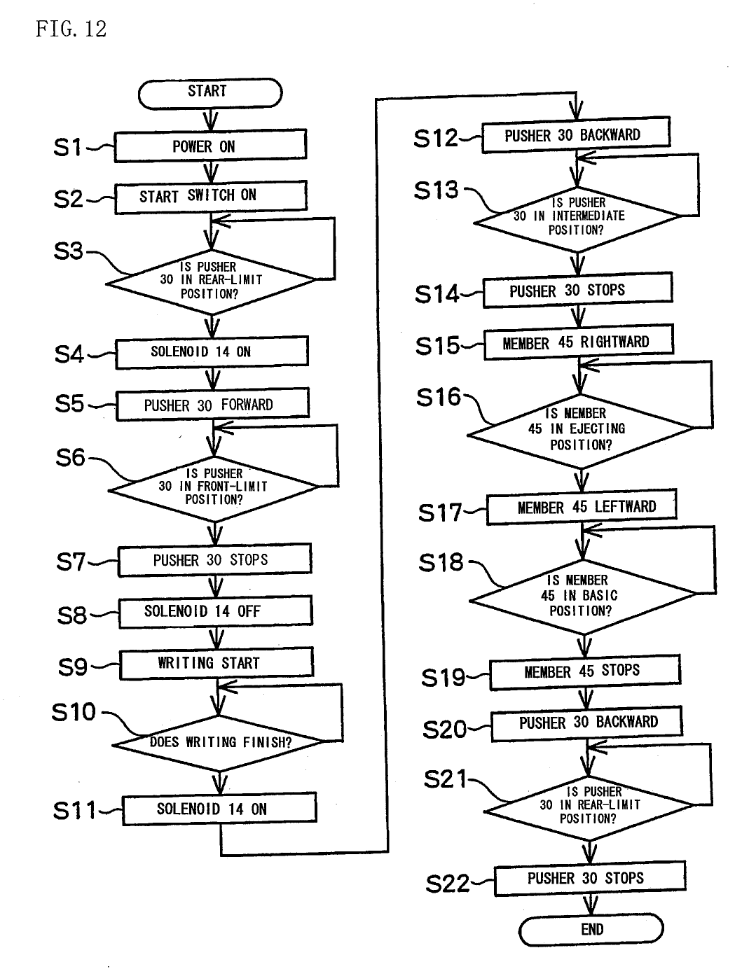

Thereafter, similar steps to after Step S18 in FIG. 12 are processed.

The present invention is not limited to the foregoing embodiment, and variations as below are possible.

(1) In the foregoing embodiment, the connector device A connects the USB port of the duplicator 3 to the plug 5b of the USB flash memory 5, but may connect various equipment to other equipment, cords and electric parts and accessories.

(2) The forcing unit 11 is not limited to a combination of the leaf spring 12 and the tension coil spring 13, but may comprise any structure that is movable between a pressing position for forcing the plug contact portion 10 of the plug disposed in the receptacle 6 and a release position for releasing the force.

1. A connector device comprising:
a receptacle;
a plug detachably disposed in the receptacle;
a receptacle contact portion in the receptacle;
a plug contact portion on the plug, the plug putting into the receptacle to enable the plug contact portion to contact the receptacle contact portion; and
a forcing unit moving between a pressing position for forcing the plug contact portion disposed in the receptacle toward the receptacle contact portion and a release position for releasing it.

2. The connector device of claim 1 wherein the forcing unit comprises a leaf spring pivotally mounted, the leaf spring coming in contact with the plug to press the plug contact portion onto the receptacle contact portion in the pressing position.

3.-5. (canceled)

6. The connector device of claim 2, wherein the forcing unit further comprises an electric actuator connected to the leaf spring to allow the leaf spring to leave the plug in the release position when the electric actuator is energized.

7. The connector device of claim 6, wherein the leaf spring is pressed onto the plug by the electric actuator in the pressing position when the electric actuator is energized.

8. The connector device of claim 6, wherein the forcing unit further comprises a pair of tension coil springs mounted to the leaf spring, the leaf spring coming in contact with the plug by the pair of tension coil spring when the electric actuator is not energized.

9. The connector device of claim 8, wherein the leaf spring comprises a vertical portion connected to the electric actuator; a plurality of elastic portions extending from a lower end of the vertical portion; a side portion pivotally mounted on a transverse shaft; and a pressing portion at an end of the elastic portion, the pressing portion coming in contact with the plug to press the plug contact portion onto the receptacle contact portion by the pair of tension coil spring when the electric actuator is not energized.

10. The connector device of claim 6, wherein the electric actuator comprises a solenoid.

11. The connector device of claim 1, wherein the plug is provided at an end of the flash memory.
